(19) United States
(12) Patent Application Publication
(10) Pub. No.: US 2025/0136848 A1
(43) Pub. Date: May 1, 2025

(54) WATER-BASED POLYMERIC PRESSURE-SENSITIVE ADHESIVE AND LABEL MATERIAL COMPRISING SAME

(71) Applicant: Jiangsu Jinghong New Materials Technology Co., Ltd., Suqian (CN)

(72) Inventors: Yinqiu LU, Suqian (CN); Shu BAI, Suqian (CN); Peilong WU, Suqian (CN); Song WU, Suqian (CN); Zhijian DU, Suqian (CN)

(73) Assignee: Jiangsu Jinghong New Materials Technology Co., Ltd., Suqian (CN)

(21) Appl. No.: 18/941,557

(22) Filed: Nov. 8, 2024

Related U.S. Application Data
(63) Continuation of application No. PCT/CN2024/127518, filed on Oct. 25, 2024.

(30) Foreign Application Priority Data
Nov. 1, 2023 (CN) 202311442249.3

(51) Int. Cl. C09J 7/38; C09J 151/00

(52) U.S. Cl. CPC C09J 7/38; C09J 151/00; C09J 2203/334; C09J 2301/302; C09J 2451/00; C09J 2467/00

(57) ABSTRACT

The present disclosure provides a water-based polymeric pressure-sensitive adhesive and a label material comprising the pressure-sensitive adhesive. The pressure-sensitive adhesive has a strong adhesive force when being used for a label material, and is easy to cut off, non-adhesive and good in re-peeling property when die-cutting processing is performed for the label material. The pressure-sensitive adhesive is prepared from 4-6 parts of water-soluble polyester, 16-18 parts of C₁-C₄ alkyl ester of methacrylic acid, 16-18 parts of C₄-C₈ alkyl ester of acrylic acid, 2-8 parts of ureido methacrylate and 4-5 parts of cycloalkyl ester of methacrylic acid, the cycloalkyl ester of methacrylic acid is C₅-C₂₀ cycloalkyl ester, and the water-soluble polyester is prepared from 1-5 parts of sulfonate for polyester modification, 10-15 parts of hydroxyalkyl ester of (methyl) acrylic acid, 60-80 parts of terephthalic acid and 20-30 parts of ethylene glycol.

### CROSS-REFERENCE TO RELATED APPLICATIONS

The application claims priority to Chinese patent application No. 202311442249.3, filed on Nov. 1, 2023, the entire contents of which are incorporated herein by reference.

### TECHNICAL FIELD

The present disclosure relates to the technical field of labels, and in particular to a water-based polymeric pressure-sensitive adhesive and a label material comprising the pressure-sensitive adhesive.

### BACKGROUND

In recent years, due to the rapid development in packaging, transportation, materials, etc., the demand for label products has been continuously expanding, and the performance requirements for label products have also been constantly changing. A well-known label material comprises a polyester-based surface material, a water-based polymeric pressure-sensitive adhesive and a substrate that are bonded to each other from top to bottom. The production process is generally as follows: applying the pressure-sensitive adhesive on the surface material, compounding the substrate and the surface material after drying to obtain a label material; and further die-cutting the label material into multiple finished labels with set sizes. During die-cutting, the surface material and the pressure-sensitive adhesive layer need to be cut off, while the substrate needs to maintain its integrity. During use, the surface material and the pressure-sensitive adhesive are removed from the substrate and attached to the surface of an applied object.

Currently, acrylate polymers obtained by copolymerization of various types of acrylate monomers are an important kind of pressure-sensitive adhesive. After years of development, researchers have continuously adjusted the polymerization formula and polymerization process of acrylate pressure-sensitive adhesive products, and introduced various functional monomers to improve their performance. However, there are still a series of problems with the use of this type of pressure-sensitive adhesive for label materials, for example, the compatibility between the pressure-sensitive adhesive and the label surface material is poor, an adhesive force is insufficient, resulting in certain adhesion with the substrate during the label removing process, which cannot achieve rapid label removing, and some residual adhesive will be left on the base paper after removing, affecting the recycling of the base paper. In addition, during the die-cutting process of label products, due to the strong resilience of the pressure-sensitive adhesive, it will rebound to its original state after die-cutting. At this time, the adhesive at the cutting position will flow towards the cut to produce bonding, resulting in adhesion during the label removing process.

### SUMMARY

In view of above, the present disclosure provides a water-based polymeric pressure-sensitive adhesive, which has a strong adhesive force when being used for a label material, is easy to cut off, non-adhesive and good in re-peeling property when die-cutting processing is performed for the label material, and will not adhere to a substrate or has residue left on a base paper after removing the label.

The present disclosure further provides a label material comprising the above water-based polymeric pressure-sensitive adhesive.

As the first aspect of the present disclosure, the present disclosure provides a water-based polymeric pressure-sensitive adhesive which is polymerized by the following raw materials in parts by weight: 4-6 parts of water-soluble polyester, 16-18 parts of C₁-C₄ alkyl ester of methacrylic acid, 16-18 parts of C₄-C₈ alkyl ester of acrylic acid, 2-8 parts of ureido methacrylate CHR¹CH—COOR² and 4-5 parts of cycloalkyl ester of methacrylic acid, wherein R¹ is H or methyl, and R² is a linear or cyclic ureido group containing 3-5 carbon atoms, and the cycloalkyl ester of methacrylic acid is C₅-C₂₀ cycloalkyl ester; and
the water-soluble polyester is polymerized by the following raw materials in parts by weight: 1-5 parts of sulfonate for polyester modification, 10-15 parts of hydroxyalkyl ester CHR³CH—COOR⁴OH of (methyl) acrylic acid, 60-80 parts of terephthalic acid and 20-30 parts of ethylene glycol, wherein R³ is H or methyl, and R⁴ is a linear or branched alkylene group containing 2-5 carbon atoms.

In the present disclosure, the term “Cₙ-Cₘ alkyl” refers to a linear or branched saturated hydrocarbon radical having n to m carbon atoms. For example, the term C₁-C₄ alkyl refers to a linear or branched saturated hydrocarbon group having 1 to 4 carbon atoms, and C₄-C₈ alkyl refers to a linear or branched saturated hydrocarbon group having 4 to 8 carbon atoms. Examples of C₁-C₄ alkyl are methyl, ethyl, propyl, 1-methylethyl, butyl, 1-methylpropyl, 2-methylpropyl or 1,1-dimethylethyl. Examples of C₄-C₈ alkyl include, but are not limited to, n-butyl, sec-butyl, isobutyl, tert-butyl, 2-methylpropyl, 1,1-dimethylethyl (tert-butyl), pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-heptyl, n-octyl, 2-octyl, and 2-ethylhexyl. The term “cycloalkyl” as used herein refers to a monocyclic or bicyclic alicyclic group that is unsubstituted or substituted by 1, 2, 3 or 4 methyl groups, wherein the total number of carbon atoms in C₅-C₂₀ cycloalkyl is 5 to 20, and the total number of carbon atoms of C₅-C₁₀ cycloalkyl is 5 to 10. Examples of C₅-C₂₀ cycloalkyl include, but are not limited to, cyclopentyl, cyclohexyl, methylcyclohexyl, dimethylcyclohexyl, cycloheptyl, cyclooctyl, cyclododecyl, cyclohexadecyl, norbornyl (-bicyclo[2.2.1]heptyl) and isobornyl (=1,7,7-trimethylbicyclo[2.2.1]heptyl).

Preferably, the ureido methacrylate CHR¹CH—COOR² is ethylene ureaethyl methacrylate.

Preferably, the hydroxyalkyl ester CHR³CH—COOR⁴OH of (methyl) acrylic acid is 2-hydroxyethyl acrylate, 3-hydroxypropyl methacrylate, 2-hydroxypropyl acrylate or 4-hydroxybutyl acrylate, and more preferably 4-hydroxybutyl acrylate.

The sulfonate for polyester modification can be selected from sulfonates commonly used in the field of water-soluble polyester in the prior art for water-soluble modification of polyester, such as 5-sodium sulfo bis-(hydroxyethyl) isophthalate.

Preferably, the cycloalkyl ester of methacrylic acid can be a cycloalkyl ester with a single or double ring structure, preferably C₅-C₁₀ cycloalkyl ester of methacrylic acid, such as isobornyl methacrylate or norbornyl methacrylate.

The water-soluble polyester and acrylic polymer can be prepared using commonly used methods in the prior art in this field, and the specific process parameters can be determined by technicians based on experiments. Preferably, the viscosity of the water-soluble polyester is 5000 mPa·s-10000 mPa·s. Specifically, the following preparation method of the water-soluble polyester can be selected: putting sulfonate for polyester modification, hydroxyalkyl ester CHR³CH—COOR⁴OH of (methyl) acrylic acid, terephthalic acid and ethylene glycol into a reaction kettle, heating to 120° C.-125° C., adding a polycondensation initiator to perform esterification reaction, after 3 h-3.5 h of reaction, raising the temperature to 210° C.-215° C., and performing polycondensation reaction for 5 h-5.5 h to obtain the water-soluble polyester. The polycondensation reaction initiator can be a conventional initiator, such as ethylene glycol antimony.

Specifically, the preparation method of the water-based polymeric pressure-sensitive adhesive includes:
(1) mixing the water-soluble polyester with C₁-C₄ alkyl ester of methacrylic acid, C₄-C₈ alkyl ester of acrylic acid, ureido methacrylate, cycloalkyl ester of methacrylic acid, and the first part of deionized water, stirring and emulsifying to obtain a monomer pre-emulsion with a solid content of 30%-50%; and
(2) heating 50-100 parts by weight of the second part of deionized water and adding 10%-20% of the monomer pre-emulsion obtained in step (1) for free radical polymerization reaction, and then adding the remaining pre-emulsion dropwise for free radical polymerization reaction, resulting in a product viscosity of 100 mPa·s-500 mPa·s.

Furthermore, the preparation method of the water-based polymeric pressure-sensitive adhesive includes:
(1) mixing the water-soluble polyester with C₁-C₄ alkyl ester of methacrylic acid, C₄-C₈ alkyl ester of acrylic acid, ureido methacrylate, cycloalkyl ester of methacrylic acid, and the first part of deionized water, free radical initiator, stirring and emulsifying to obtain a monomer pre-emulsion, wherein the weight of the initiator is 0.3%-0.8% of the total weight of water-soluble polyester, C₁-C₄ alkyl ester of methacrylic acid, C₄-C₈ alkyl ester of acrylic acid, ureido methacrylate and cycloalkyl ester of methacrylic acid; and
(2) heating the second part of deionized water to 78° C.-82° C., adding 10%-20% of the monomer pre-emulsion obtained in step (1), reacting for 15-25 minutes, adding the remaining monomer pre-emulsion dropwise within 2-5 hours, and keeping it at 80° C.-85° C. for 1-2 hours after the adding is completed; cooling down to below 45° C., adjusting the pH value to 7-8, finally adding a wetting agent and a defoaming agent, stirring evenly, and filtering to obtain a water-based polymeric pressure-sensitive adhesive. The concentration of the obtained pressure-sensitive adhesive is 35%-42%. Sometimes, a small amount of free radical initiator can be added as appropriate during the heat preservation reaction stage to complete the monomer reaction.

The free radical initiator, wetting agent and defoaming agent can be conventionally selected in the art. For example, the free radical initiator can be ammonium persulfate or potassium persulfate alone; or a redox system initiator. Of course, as a common sense, the oxidizing agent and reducing agent in the redox system should be added separately. In this case, the monomer pre-emulsion obtained in step (1) can only comprise at most one of them, such as an oxidizing agent; the wetting agent is an acetylene glycol or an organic silicone; and the defoaming agent is a mineral oil or an organic silicone.

As the second aspect of the present disclosure, the present disclosure further provides a label material comprising the above water-based polymeric pressure-sensitive adhesive, and the label material comprises a polyester-based surface material and the water-based polymeric pressure-sensitive adhesive that are bonded to each other.

In the embodiment of the present disclosure, the surface material is polymerized by the following raw materials in parts by weight: 40-60 parts of polyethylene terephthalate-1,4-cyclohexanedimeth yleneterephthalate (PETG), 15-35 parts of polyethylene terephthalate (PET), 15-20 parts of polycarbonate, and 0.1-1.0 parts of slipping agent. Specifically, PET, PETG, polycarbonate, and the slipping agent are mixed and melted, uniaxially or biaxially stretched after casting, rapidly cooled and shaped to produce the surface material, and preferably, biaxially stretched by 3-5 times after casting, cooled and shaped at 25° C.-55° C. to produce the surface material.

Among them, as a preferred solution, PETG has a number average molecular weight of 50,000-80,000 and an intrinsic viscosity of 0.80 dl/g-0.85 dl/g; PET has a number average molecular weight of 20,000-30,000, and an intrinsic viscosity of 0.62 dl/g-0.67 dl/g; and polycarbonate has a number average molecular weight of 20,000-35,000.

The slipping agent can be made of commonly known materials in the art, preferably silica, glass beads, kaolin or aluminum oxide.

When making a label material based on the prior art, silicone is applied on a substrate and the amount of silicone applied is controlled at 0.1 g/m²-0.5 g/m²; the water-based polymeric pressure-sensitive adhesive is applied on the surface material; after drying the surface material, the substrate and surface material are compounded into a label material, with the water-based polymeric pressure-sensitive adhesive located between the substrate and surface material; and the label material is die-cut into multiple finished labels with set sizes.

The substrate can be made of commonly known materials in the art. For example, a preparation method of the substrate comprises: melting polyethylene terephthalate, biaxially stretching by 2 times after casting, followed by heat shaping at 220° C.

The technical solution provided by the present disclosure has the following advantages:
The water-based polymeric pressure-sensitive adhesive provided by the present disclosure can effectively improve the wettability, adhesion, and bonding property of the water-based polymer pressure-sensitive adhesive to the surface material, so that the surface material and the pressure-sensitive adhesive of the label are firmly attached to each other during the label removing process. The surface material attached with the pressure-sensitive adhesive is easy to detach from the substrate, and the label removing process can be quickly completed, thereby avoiding poor label removing due to excessive adhesion to the substrate. After label removing, there will be no residual adhesive left on the base paper, avoiding affecting the recycling of the base paper. The inventors speculate that the reasons are as follows:
the water-based polymeric pressure-sensitive adhesive described in the present disclosure is modified by introducing water-soluble polyester to make the molecular chain structure of the pressure-sensitive adhesive similar to the polyester surface material of the label, and based on the principle of “like dissolves like”, its compatibility with the surface material is improved, and its wettability to the surface material is enhanced; and at the same time, the sulfonic acid groups in the water-soluble polyester have hydrophilicity, which can further enhance the wettability of the water-based polymeric pressure-sensitive adhesive, thereby improving the adhesion of the water-based polymeric pressure-sensitive adhesive to the surface material.

The water-soluble polyester has poor compatibility with acrylic polymer. Therefore, if the water-soluble polyester and acrylic polymer are directly physically mixed, or the acrylic monomer is polymerized in the presence of the water-soluble polyester to obtain acrylic polymer, using the water-soluble polyester to modify the acrylic polymer pressure-sensitive adhesive in these two ways cannot solve the compatibility problem between them. The resulting pressure-sensitive adhesive mixture is prone to opacity and unevenness, both of which are unacceptable during the use of a label material. The present disclosure ingeniously introduces hydroxyl (meth)acrylate monomer into the water-soluble polyester, thereby introducing a double bond structure into the water-soluble polyester. The resulting water-soluble polyester can undergo free radical copolymerization reaction with acrylic monomer, and the polyester structure modifies the acrylic polymer in a covalent bonding manner, solving the compatibility problem between them and achieving significant improvement in the wettability and adhesion of pressure-sensitive adhesive to the polyester-based surface material. The resulting pressure-sensitive adhesive is transparent, uniform, and reliable and stable in performance.

Ureido methacrylate with appropriate copolymerization activity is successfully selected, and urea based structures are introduced into the water-based polymeric pressure-sensitive adhesive. The active hydrogen (H connected to N) in ureido methacrylate can undergo hydrogen bond crosslinking with ester groups in other components of the water-based polymeric pressure-sensitive adhesive and ester groups in the surface material, thereby increasing the bonding property and adhesion of the pressure-sensitive adhesive to the surface material. At the same time, when the urea-containing structure is a heterocyclic structure, it has a significant effect on improving the aging resistance of the pressure-sensitive adhesive.

2. The water-based polymeric pressure-sensitive adhesive provided by the present disclosure can provide intermolecular forces mainly through a hydrogen bond (as mentioned earlier), with high molecular cross-linking density and multiple cross-linking points, which can enhance the internal cross-linking strength and improve the cohesion of the pressure-sensitive adhesive; the cycloalkyl ester of methacrylic acid has a strong inhibitory effect on the movement of polymer segments; and as a result, the hardness of the pressure-sensitive adhesive is improved and its rebound flowability is reduced. When used as a label adhesive, there will be no adhesive filament adhesion during the die-cutting process, avoiding rebound after die-cutting and flowing towards the cut to produce bonding, thus avoiding the situation of adjacent labels adhering to each other after die-cutting. Traditional labels have the problem of adhesion between two adjacent labels after die-cutting, which requires providing a waste discharge zone, resulting in waste of a lot of substrates and adhesive. However, when the water-based polymeric pressure-sensitive adhesive provided by the present disclosure is applied to labels, two adjacent labels are less likely to adhere during the die-cutting process, so that no waste discharge zone is provided during label die-cutting, achieving zero label waste discharge, and avoiding the problem of the label removing failure due to adjacent label adhesion during label use, reducing label waste during use.

### DETAILED DESCRIPTION OF THE EMBODIMENTS

A clear and complete description of the technical solution of the present disclosure will be provided in conjunction with specific implementations. Apparently, the described embodiments are only part, not all, of the embodiments of the present disclosure. Based on the embodiments in the present disclosure, all other embodiments obtained by those having ordinary skills in the art without creative work shall fall within the protection scope of the present disclosure.

In the specific implementation of the present disclosure, the following raw materials are used: methyl methacrylate, ethyl methacrylate, n-butyl methacrylate, butyl acrylate, isooctyl acrylate, ethylene ureaethyl methacrylate, isobornyl methacrylate, norbornyl methacrylate, 4-hydroxybutyl acrylate, industrial grade, Shanghai Jingrex Chemical Industry Co., Ltd; terephthalic acid, industrial grade, Suzhou Suyuxuan Plastic Co., Ltd; 5-sodium sulfo bis-(hydroxyethyl) isophthalate, industrial grade, Jingmen Dongxin Biotechnology Co., Ltd.; polyethylene terephthalate (PET) with a molecular weight of 72,000, polyethylene terephthalate-1,4-cyclohexanedimeth yleneterephthalate (PETG) with a molecular weight of 75,000, industrial grade, Suzhou Aokai Polymer Materials Co., Ltd.; polycarbonate, industrial grade, Nantong Xingchen Synthetic Materials Co., Ltd.; ethylene glycol, slipping agents (including silica, glass beads, kaolin or aluminum oxide), chemically pure, commercially available; ammonium persulfate, potassium persulfate, industrial grade, Aijian Degusa (Shanghai) Co., Ltd.; acetylene glycol wetting agent 104E, industrial grade, Shanghai Sangjing Chemical Co., Ltd.; organic silicone wetting agent 122, industrial grade, Zhuhai Xiande New Materials Co., Ltd.; organic silicon defoaming agent TSA-830, industrial grade, Jiangsu Tengda Additive Co., Ltd.; and mineral oil defoaming agent A-10, industrial grade, Tianjin Hepufile New Materials Co., Ltd.

As the first aspect of the present disclosure, the present disclosure provides a water-based polymeric pressure-sensitive adhesive which is polymerized by the following raw materials in parts by weight: 4-6 parts of water-soluble polyester, 16-18 parts of C₁-C₄ alkyl ester of methacrylic acid, 16-18 parts of C₄-C₈ alkyl ester of acrylic acid, 2-8 parts of ureido methacrylate CHR¹CH—COOR² and 4-5 parts of cycloalkyl ester of methacrylic acid, wherein R¹ is H or methyl, and R² is a linear or cyclic ureido group containing 3-5 carbon atoms, and the cycloalkyl ester of methacrylic acid is C₅-C₂₀ cycloalkyl ester; and
the water-soluble polyester is polymerized by the following raw materials in parts by weight: 1-5 parts of sulfonate for polyester modification, 10-15 parts of hydroxyalkyl ester CHR³CH—COOR⁴OH of (methyl) acrylic acid, 60-80 parts of terephthalic acid and 20-30 parts of ethylene glycol, preferably, 3 parts of sulfonate for polyester modification, 15 parts of hydroxyalkyl ester CHR³CH—COOR⁴OH of (methyl) acrylic acid, 80 parts of terephthalic acid and 20 parts of ethylene glycol, wherein R³ is H or methyl, and R⁴ is a linear or branched alkylene group containing 2-5 carbon atoms.

Preferably, the hydroxyalkyl ester CHR³CH—COOR⁴OH of (methyl) acrylic acid is 2-hydroxyethyl acrylate, 3-hydroxypropyl methacrylate, 2-hydroxypropyl acrylate or 4-hydroxybutyl acrylate, and more preferably 4-hydroxybutyl acrylate.

The sulfonate for polyester modification can be selected from sulfonates commonly used in the field of water-soluble polyester in the prior art for water-soluble modification of polyester, such as 5-sodium sulfo bis-(hydroxyethyl) isophthalate.

The C₁-C₄ alkyl ester of methacrylic acid includes, but is not limited to, methyl methacrylate, ethyl methacrylate, n-propyl methacrylate, isopropyl methacrylate, n-butyl methacrylate, sec-butyl methacrylate, isobutyl methacrylate or tert-butyl methacrylate, especially methyl methacrylate. The weight proportion of C₁-C₄ alkyl ester of methacrylic acid in the raw material is 16-18 parts, preferably 17 parts.

The C₄-C₈ alkyl ester of acrylic acid includes, but is not limited to, at least one of butyl acrylate, pentyl acrylate, heptyl acrylate, and isooctyl acrylate, especially butyl acrylate and/or isooctyl acrylate. The weight proportion of C₄-C₈ alkyl ester of acrylic acid in the raw material is 16-18 parts, preferably 17 parts.

Preferably, the ureido methacrylate CHR¹CH—COOR² is ethylene ureaethyl methacrylate. The weight proportion of the ureido methacrylate CHR¹CH—COOR² in the raw material is 2-8 parts, preferably 5 parts.

Preferably, the cycloalkyl ester of methacrylic acid can be a cycloalkyl ester with a single or double ring structure, preferably C₅-C₁₀ cycloalkyl ester of methacrylic acid, such as isobornyl methacrylate or norbornyl methacrylate. The weight proportion of cycloalkyl ester of methacrylic acid in the raw material is 4-5 parts, preferably 5 parts.

The water-soluble polyester and acrylic polymer can be prepared using commonly used methods in the prior art in this field, and the specific process parameters can be determined by technicians based on experiments. Preferably, the viscosity of the water-soluble polyester is 5000 mPa·s-10000 mPa·s. Specifically, the following preparation method of the water-soluble polyester can be selected: putting sulfonate for polyester modification, hydroxyalkyl ester CHR³CH—COOR⁴OH of (methyl) acrylic acid, terephthalic acid and ethylene glycol into a reaction kettle, heating to 120° C.-125° C., adding a polycondensation initiator to perform esterification reaction, after 3 h-3.5 h of reaction, raising the temperature to 210° C.-215° C., and performing polycondensation reaction for 5 h-5.5 h to obtain the water-soluble polyester. The polycondensation reaction initiator can be a conventional initiator, such as ethylene glycol antimony.

Specifically, the preparation method of the water-based polymeric pressure-sensitive adhesive includes:
(1) mixing the water-soluble polyester with C₁-C₄ alkyl ester of methacrylic acid, C₄-C₈ alkyl ester of acrylic acid, ureido methacrylate, cycloalkyl ester of methacrylic acid, and the first part of deionized water, stirring and emulsifying to obtain a monomer pre-emulsion with a solid content of 30%-50%; and
(2) heating 50-100 parts by weight of the second part of deionized water and adding 10%-20% of the monomer pre-emulsion obtained in step (1) for free radical polymerization reaction, and then adding the remaining pre-emulsion dropwise for free radical polymerization reaction, resulting in a product viscosity of 100 mPa·s-500 mPa·s.

As a common knowledge in the art, the above free radical polymerization reaction requires the addition of a free radical initiator. The method of adding the free radical initiator can be determined by technical personnel according to actual needs. The free radical initiator can be added in step (1) as part of the monomer pre-emulsion to the reaction system in step (2), or it can be dropwise added simultaneously or separately with the monomer pre-emulsion in step (2). No further details will be given here.

Furthermore, the preparation method of the water-based polymeric pressure-sensitive adhesive includes:
(1) mixing the water-soluble polyester with C₁-C₄ alkyl ester of methacrylic acid, C₄-C₈ alkyl ester of acrylic acid, ureido methacrylate, cycloalkyl ester of methacrylic acid, and the first part of deionized water, free radical initiator, stirring and emulsifying to obtain a monomer pre-emulsion, wherein the weight of the initiator is 0.3%-0.8% of the total weight of water-soluble polyester, C₁-C₄ alkyl ester of methacrylic acid, C₄-C₈ alkyl ester of acrylic acid, ureido methacrylate and cycloalkyl ester of methacrylic acid; and
(2) heating the second part of deionized water to 78° C.-82° C., adding 10%-20% of the monomer pre-emulsion obtained in step (1), reacting for 15-25 minutes, adding the remaining monomer pre-emulsion dropwise within 2-5 hours, and keeping it at 80° C.-85° C. for 1-2 hours after the adding is completed; cooling down to below 45° C., adjusting the pH value to 7-8, finally adding a wetting agent and a defoaming agent, stirring evenly, and filtering to obtain a water-based polymeric pressure-sensitive adhesive. The concentration of the obtained pressure-sensitive adhesive is 35%-42%. Sometimes, a small amount of free radical initiator can be added as appropriate during the heat preservation reaction stage to complete the monomer reaction.

The free radical initiator, wetting agent and defoaming agent can be conventionally selected in the art. For example, the free radical initiator can be ammonium persulfate or potassium persulfate alone; or a redox system initiator. Of course, as a common sense, the oxidizing agent and reducing agent in the redox system should be added separately. In this case, the monomer pre-emulsion obtained in step (1) can only comprise at most one of them, such as an oxidizing agent; the wetting agent is an acetylene glycol or an organic silicone; and the defoaming agent is a mineral oil or an organic silicone.

The viscosity of the water-soluble polyester and water-based polymeric pressure-sensitive adhesive is measured by a rotational viscometer. The rotational viscometer is commercially available, and the viscosity described in the following examples is specifically measured using the NDJ-5S digital display type rotational viscometer produced by Shanghai Jingqi Instrument Co., Ltd.

As the second aspect of the present disclosure, the present disclosure further provides a label material comprising the above water-based polymeric pressure-sensitive adhesive, and the label material comprises a polyester-based surface material and the water-based polymeric pressure-sensitive adhesive that are bonded to each other.

### EXAMPLE 1

This example provides a water-based polymeric pressure-sensitive adhesive comprising the following raw materials: 50 g of water-soluble polyester, 170 g of methyl methacrylate, 70 g of butyl acrylate, 100 g of isooctyl acrylate, 50 g of ethylene ureaethyl methacrylate, and 50 g of isobornyl methacrylate.

The preparation method of the water-soluble polyester included: putting 70 g of terephthalic acid, 20 g of ethylene glycol, 3 g of 5-sodium sulfo bis-(hydroxyethyl) isophthalate and 15 g of 4-hydroxybutyl acrylate into a reaction kettle, heating to 125° C., adding 2 g of initiator antimony glycol for esterification reaction, after 3 h of reaction, raising the temperature to 215° C. to perform polycondensation reaction, and after 5 h of reaction, obtaining the water-soluble polyester with a viscosity of 6500 mPa·s after discharging.

In this example, the specific preparation method of the water-based polymeric pressure-sensitive adhesive included the following steps:
(1) mixing, stirring and emulsifying 50 g of water-soluble polyester, 170 g of methyl methacrylate, 70 g of butyl acrylate, 100 g of isooctyl acrylate, 50 g of ethylene ureaethyl methacrylate, 50 g of isobornyl methacrylate, 700 g of deionized water and 2 g of ammonium persulfate to obtain a monomer pre-emulsion with a solid content of 38%; and
(2) heating 100 g of deionized water to 80° C., adding 73.5 g of the monomer pre-emulsion produced in step (1) for reaction for 20 min, dropwise adding the remaining monomer pre-emulsion within 4 h, and keeping at 80° C. for 1 h after the adding was completed; cooling down to below 45° C., adding a pH adjuster to adjust the pH value of the emulsion to 7-8, and finally adding 1 g of acetylene glycol wetting agent and 1 g of organic silicone defoaming agent, stirring evenly, and filtering to obtain a water-based polymeric pressure-sensitive adhesive with a concentration of 35% and a viscosity of 150 mPa·s.

A label material was prepared by: applying silicone on a substrate and controlling the amount of silicone applied at 0.35 g/m², applying the above water-based polymeric pressure-sensitive adhesive on the surface material, compounding the substrate and surface material into a label material after drying, and die-cutting the label material into multiple finished labels with set sizes. The surface material was prepared by: mixing and melting 50 parts of amorphous transparent or white PETG, 30 parts of PET, 19.5 parts of polycarbonate, and 0.5 parts of slipping agent (all in parts by weight), biaxially stretching by 4.4 times after casting, and then rapidly cooling and shaping at 30° C. The slipping agent was aluminum oxide; and the substrate was produced by melting polyethylene terephthalate, biaxially stretching by 2 times after casting, and followed by heat shaping at 220° C.

### EXAMPLE 2

This example provides a water-based polymeric pressure-sensitive adhesive comprising the following raw materials: 50 g of water-soluble polyester, 170 g of methyl methacrylate, 70 g of butyl acrylate, 100 g of isooctyl acrylate, 30 g of ethylene ureaethyl methacrylate, and 50 g of isobornyl methacrylate.

The preparation method of the water-soluble polyester included: putting 70 g of terephthalic acid, 20 g of ethylene glycol, 3 g of 5-sodium sulfo bis-(hydroxyethyl) isophthalate and 15 g of 4-hydroxybutyl acrylate into a reaction kettle, heating to 125° C., adding 2 g of initiator antimony glycol for esterification reaction, after 3 h of reaction, raising the temperature to 215° C. to perform polycondensation reaction, and after 5 h of reaction, obtaining the water-soluble polyester with a viscosity of 7600 mPa·s after discharging.

In this example, the specific preparation method of the water-based polymeric pressure-sensitive adhesive included the following steps:
(1) mixing, stirring and emulsifying 50 g of water-soluble polyester, 170 g of methyl methacrylate, 70 g of butyl acrylate, 100 g of isooctyl acrylate, 30 g of ethylene ureaethyl methacrylate, 50 g of isobornyl methacrylate, 580 g of deionized water and 2 g of ammonium persulfate to obtain a monomer pre-emulsion with a solid content of 40%; and
(2) heating 80 g of deionized water to 80° C., adding 73.5 g of the monomer pre-emulsion produced in step (1) for reaction for 20 min, dropwise adding the remaining monomer pre-emulsion within 4 h, and keeping at 80° C. for 1 h after the adding was completed; cooling down to below 45° C., adding a pH adjuster to adjust the pH value of the emulsion to 7-8, and finally adding 1 g of acetylene glycol wetting agent and 1 g of organic silicone defoaming agent, stirring evenly, and filtering to obtain a water-based polymeric pressure-sensitive adhesive with a concentration of 38% and a viscosity of 120 mPa·s.

A label material was prepared by: applying silicone on a substrate and controlling the amount of silicone applied at 0.35 g/m², applying the above water-based polymeric pressure-sensitive adhesive on the surface material, compounding the substrate and surface material into a label material after drying, and die-cutting the label material into multiple finished labels with set sizes. The surface material was prepared by: mixing and melting 50 parts of amorphous transparent or white PETG, 30 parts of PET, 19.5 parts of polycarbonate, and 0.5 parts of slipping agent (all in parts by weight), biaxially stretching by 4.4 times after casting, and then rapidly cooling and shaping at 30° C. The slipping agent was silica; and the substrate was produced by melting polyethylene terephthalate, biaxially stretching by 2 times after casting, and followed by heat shaping at 220° C.

### EXAMPLE 3

This example provides a water-based polymeric pressure-sensitive adhesive comprising the following raw materials: 50 g of water-soluble polyester, 170 g of methyl methacrylate, 70 g of butyl acrylate, 100 g of isooctyl acrylate, 30 g of ethylene ureaethyl methacrylate, and 50 g of isobornyl methacrylate.

The preparation method of the water-soluble polyester included: putting 75 g of terephthalic acid, 20 g of ethylene glycol, 3 g of 5-sodium sulfo bis-(hydroxyethyl) isophthalate and 13 g of 4-hydroxybutyl acrylate into a reaction kettle, heating to 125° C., adding 2 g of initiator antimony glycol for esterification reaction, after 3 h of reaction, raising the temperature to 215° C. to perform polycondensation reaction, and after 5 h of reaction, obtaining the water-soluble polyester with a viscosity of 7500 mPa·s after discharging.

In this example, the specific preparation method of the water-based polymeric pressure-sensitive adhesive included the following steps:
(1) mixing, stirring and emulsifying 50 g of water-soluble polyester, 170 g of methyl methacrylate, 70 g of butyl acrylate, 100 g of isooctyl acrylate, 30 g of ethylene ureaethyl methacrylate, 50 g of isobornyl methacrylate, 600 g of deionized water and 2 g of ammonium persulfate to obtain a monomer pre-emulsion with a solid content of 44%; and
(2) heating 90 g of deionized water to 80° C., adding 73.5 g of the monomer pre-emulsion produced in step (1) for reaction for 20 min, dropwise adding the remaining monomer pre-emulsion within 4 h, and keeping at 80° C. for 1 h after the adding was completed; cooling down to below 45° C., adding a pH adjuster to adjust the pH value of the emulsion to 7-8, and finally adding 1 g of acetylene glycol wetting agent and 1 g of organic silicone defoaming agent, stirring evenly, and filtering to obtain a water-based polymeric pressure-sensitive adhesive with a concentration of 40.5% and a viscosity of 180 mPa·s.

A label material was prepared by: applying silicone on a substrate and controlling the amount of silicone applied at 0.35 g/m², applying the above water-based polymeric pressure-sensitive adhesive on the surface material, compounding the substrate and surface material into a label material after drying, and die-cutting the label material into multiple finished labels with set sizes. The surface material was prepared by: mixing and melting 50 parts of amorphous transparent or white PETG, 30 parts of PET, 19.5 parts of polycarbonate, and 0.5 parts of slipping agent (all in parts by weight), biaxially stretching by 4.4 times after casting, and then rapidly cooling and shaping at 30° C. The slipping agent was kaolin; and the substrate was produced by melting polyethylene terephthalate, biaxially stretching by 2 times after casting, and followed by heat shaping at 220° C.

### EXAMPLE 4

This example provides a water-based polymeric pressure-sensitive adhesive comprising the following raw materials: 50 g of water-soluble polyester, 170 g of methyl methacrylate, 70 g of butyl acrylate, 100 g of isooctyl acrylate, 50 g of ethylene ureaethyl methacrylate, and 50 g of isobornyl methacrylate.

The preparation method of the water-soluble polyester included: putting 75 g of terephthalic acid, 20 g of ethylene glycol, 3 g of 5-sodium sulfo bis-(hydroxyethyl) isophthalate and 12 g of 4-hydroxybutyl acrylate into a reaction kettle, heating to 125° C., adding 2 g of initiator antimony glycol for esterification reaction, after 3 h of reaction, raising the temperature to 215° C. to perform polycondensation reaction, and after 5 h of reaction, obtaining the water-soluble polyester with a viscosity of 7100 mPa·s after discharging.

In this example, the specific preparation method of the water-based polymeric pressure-sensitive adhesive included the following steps:
(1) mixing, stirring and emulsifying 50 g of water-soluble polyester, 170 g of methyl methacrylate, 70 g of butyl acrylate, 100 g of isooctyl acrylate, 50 g of ethylene ureaethyl methacrylate, 50 g of isobornyl methacrylate, 620 g of deionized water and 2 g of ammonium persulfate to obtain a monomer pre-emulsion with a solid content of 44%; and
(2) heating 60 g of deionized water to 80° C., adding 73.5 g of the monomer pre-emulsion produced in step (1) for reaction for 20 min, dropwise adding the remaining monomer pre-emulsion within 4 h, and keeping at 80° C. for 1 h after the adding was completed; cooling down to below 45° C., adding a pH adjuster to adjust the pH value of the emulsion to 7-8, and finally adding 1 g of acetylene glycol wetting agent and 1 g of organic silicone defoaming agent, stirring evenly, and filtering to obtain a water-based polymeric pressure-sensitive adhesive with a concentration of 41.8% and a viscosity of 190 mPa·s.

A label material was prepared by: applying silicone on a substrate and controlling the amount of silicone applied at 0.35 g/m², applying the above water-based polymeric pressure-sensitive adhesive on the surface material, compounding the substrate and surface material into a label material after drying, and die-cutting the label material into multiple finished labels with set sizes. The surface material was prepared by: mixing and melting 50 parts of amorphous transparent or white PETG, 30 parts of PET, 19.5 parts of polycarbonate, and 0.5 parts of slipping agent (all in parts by weight), biaxially stretching by 4.4 times after casting, and then rapidly cooling and shaping at 30° C. The slipping agent was silica; and the substrate was produced by melting polyethylene terephthalate, biaxially stretching by 2 times after casting, and followed by heat shaping at 220° C.

### Comparative Example 1

This comparative example provides a water-based polymeric pressure-sensitive adhesive comprising the following raw materials: 50 g of water-soluble polyester, 170 g of methyl methacrylate, 70 g of butyl acrylate, 100 g of isooctyl acrylate, and 50 g of isobornyl methacrylate.

The preparation method of the water-soluble polyester included: putting 75 g of terephthalic acid, 20 g of ethylene glycol, 3 g of 5-sodium sulfo bis-(hydroxyethyl) isophthalate and 15 g of 4-hydroxybutyl acrylate into a reaction kettle, heating to 125° C., adding 2 g of initiator antimony glycol for esterification reaction, after 3 h of reaction, raising the temperature to 215° C. to perform polycondensation reaction, and after 5 h of reaction, obtaining the water-soluble polyester with a viscosity of 8500 mPa·s after discharging.

The specific preparation method of the water-based polymeric pressure-sensitive adhesive included the following steps:
(1) mixing, stirring and emulsifying 50 g of water-soluble polyester, 170 g of methyl methacrylate, 70 g of butyl acrylate, 100 g of isooctyl acrylate, 50 g of isobornyl methacrylate, 500 g of deionized water and 2 g of ammonium persulfate to obtain a monomer pre-emulsion with a solid content of 46.8%; and
(2) heating 90 g of deionized water to 80° C., adding 73.5 g of the monomer pre-emulsion produced in step (1) for reaction for 20 min, dropwise adding the remaining monomer pre-emulsion within 4 h, and keeping at 80° C. for 1 h after the adding was completed; cooling down to below 45° C., adding a pH adjuster to adjust the pH value of the emulsion to 7-8, and finally adding 1 g of acetylene glycol wetting agent and 1 g of organic silicone defoaming agent, stirring evenly, and filtering to obtain a water-based polymeric pressure-sensitive adhesive with a concentration of 42.7% and a viscosity of 210 mPa·s.

A label material was prepared by: applying silicone on a substrate and controlling the amount of silicone applied at 0.35 g/m², applying the above water-based polymeric pressure-sensitive adhesive on the surface material, compounding the substrate and surface material into a label material after drying, and die-cutting the label material into multiple finished labels with set sizes. The surface material was prepared by: mixing and melting 50 parts of amorphous transparent or white PETG, 30 parts of PET, 19.5 parts of polycarbonate, and 0.5 parts of slipping agent (all in parts by weight), biaxially stretching by 4.4 times after casting, and then rapidly cooling and shaping at 30° C. The slipping agent was aluminum oxide; and the substrate was produced by melting polyethylene terephthalate, biaxially stretching by 2 times after casting, and followed by heat shaping at 220° C.

### Comparative Example 2

This comparative example provides a water-based polymeric pressure-sensitive adhesive comprising the following raw materials: 50 g of water-soluble polyester, 170 g of methyl methacrylate, 70 g of butyl acrylate, 100 g of isooctyl acrylate, 50 g of ethylene ureaethyl methacrylate, and 50 g of isobornyl methacrylate.

The preparation method of the water-soluble polyester included: putting 75 g of terephthalic acid, 20 g of ethylene glycol, and 3 g of 5-sodium sulfo bis-(hydroxyethyl) isophthalate into a reaction kettle, heating to 125° C., adding 2 g of initiator antimony glycol for esterification reaction, after 3 h of reaction, raising the temperature to 215° C. to perform polycondensation reaction, and after 5 h of reaction, obtaining the water-soluble polyester with a viscosity of 8200 mPa·s after discharging.

The specific preparation method of the water-based polymeric pressure-sensitive adhesive included the following steps:
(1) mixing, stirring and emulsifying 50 g of water-soluble polyester, 170 g of methyl methacrylate, 70 g of butyl acrylate, 100 g of isooctyl acrylate, 50 g of ethylene ureaethyl methacrylate, 50 g of isobornyl methacrylate, 600 g of deionized water and 2 g of ammonium persulfate to obtain a monomer pre-emulsion with a solid content of 47%; and
(2) heating 100 g of deionized water to 80° C., adding 73.5 g of the monomer pre-emulsion produced in step (1) for reaction for 20 min, dropwise adding the remaining monomer pre-emulsion within 4 h, and keeping at 80° C. for 1 h after the adding was completed, cooling down to 65° C. for heat preservation reaction for 1 h, cooling down to below 45° C., adding a pH adjuster to adjust the pH value of the emulsion to 7-8, and finally adding 1 g of acetylene glycol wetting agent and 1 g of organic silicone defoaming agent, stirring evenly, and filtering to obtain a water-based polymeric pressure-sensitive adhesive with a concentration of 43.5% and a viscosity of 240 mPa·s.

A label material was prepared by: applying silicone on a substrate and controlling the amount of silicone applied at 0.35 g/m², applying the above water-based polymeric pressure-sensitive adhesive on the surface material, compounding the substrate and surface material into a label material after drying, and die-cutting the label material into multiple finished labels with set sizes. The surface material was prepared by: mixing and melting 50 parts of amorphous transparent or white PETG, 30 parts of PET, 19.5 parts of polycarbonate, and 0.5 parts of slipping agent (all in parts by weight), biaxially stretching by 4.4 times after casting, and then rapidly cooling and shaping at 30° C. The slipping agent was kaolin; and the substrate was produced by melting polyethylene terephthalate, biaxially stretching by 2 times after casting, and followed by heat shaping at 220° C.

### Comparative Example 3

This comparative example provides a water-based polymeric pressure-sensitive adhesive comprising the following raw materials: 50 g of water-soluble polyester, 170 g of methyl methacrylate, 70 g of butyl acrylate, 100 g of isooctyl acrylate, 50 g modified hydroxyethyl urea acrylate (produced by Guangzhou Sanwang Chemical Materials Co., Ltd., model SW910), and 50 g of isobornyl methacrylate.

The preparation method of the water-soluble polyester included: putting 75 g of terephthalic acid, 20 g of ethylene glycol, 3 g of 5-sodium sulfo bis-(hydroxyethyl) isophthalate and 14 g of 4-hydroxybutyl acrylate into a reaction kettle, heating to 125° C., adding 2 g of initiator antimony glycol for esterification reaction, after 3 h of reaction, raising the temperature to 215° C. to perform polycondensation reaction, and after 5 h of reaction, obtaining the water-soluble polyester with a viscosity of 7400 mPa·s after discharging.

The specific preparation method of the water-based polymeric pressure-sensitive adhesive included the following steps:
(1) mixing, stirring and emulsifying 50 g of water-soluble polyester, 170 g of methyl methacrylate, 70 g of butyl acrylate, 100 g of isooctyl acrylate, 50 g modified hydroxyethyl urea acrylate, 50 g of isobornyl methacrylate, 680 g of deionized water and 2 g of ammonium persulfate to obtain a monomer pre-emulsion with a solid content of 44.2%; and
(2) heating 80 g of deionized water to 80° C., adding 73.5 g of the monomer pre-emulsion produced in step (1) for reaction for 20 min, dropwise adding the remaining monomer pre-emulsion within 4 h, and keeping at 80° C. for 1 h after the adding was completed, cooling down to 65° C. for heat preservation reaction for 1 h, cooling down to below 45° C., adding a pH adjuster to adjust the pH value of the emulsion to 7-8, and finally adding 1 g of acetylene glycol wetting agent and 1 g of organic silicone defoaming agent, stirring evenly, and filtering to obtain a water-based polymeric pressure-sensitive adhesive with a concentration of 41.5% and a viscosity of 170 mPa·s.

A label material was prepared by: applying silicone on a substrate and controlling the amount of silicone applied at 0.35 g/m², applying the above water-based polymeric pressure-sensitive adhesive on the surface material, compounding the substrate and surface material into a label material after drying, and die-cutting the label material into multiple finished labels with set sizes. The surface material was prepared by: mixing and melting 50 parts of amorphous transparent or white PETG, 30 parts of PET, 19.5 parts of polycarbonate, and 0.5 parts of slipping agent (all in parts by weight), biaxially stretching by 4.4 times after casting, and then rapidly cooling and shaping at 30° C. The slipping agent was silica; and the substrate was produced by melting polyethylene terephthalate, biaxially stretching by 2 times after casting, and followed by heat shaping at 220° C.

### Application Experiment Examples

The label materials prepared in Examples 1-4 and the label materials prepared in Comparative Examples 1-3 were tested for initial adhesion, static shear adhesion, and 180° peeling strength respectively, and the degree of adhesion between two adjacent label materials after die-cutting was observed. The test results are shown in Table 1.

Test method: the initial adhesion was measured according to “Test Method of Adhesive Tapes-Loop Track” GB/T 31125-2014; the static shear adhesion was measured according to “Measurement of Static Shear Adhesion for Adhesive Tapes” GB/T 4851-2014; and 180° peeling strength was measured according to “Measurement of Peel Adhesion Properties of Adhesive Tapes” GB/T 2792-2014.

TABLE 1
Performance test results

| | Initial | | | 180° | |
|---|---|---|---|---|---|
| | adhesion | | | peeling | |
| | force | Static shear | | force | |
| Test group | N/25 mm | adhesion | | N/25 mm | Anti-adhesion |
| Example 1 | 16.3 | >1000 | h | 14.8 | Non-adhesive |
| Example 2 | 16.8 | >1000 | h | 14.1 | Non-adhesive |
| Example 3 | 16.6 | >1000 | h | 15.2 | Non-adhesive |
| Example 4 | 15.8 | >1000 | h | 14.9 | Non-adhesive |
| Comparative | 20.1 | <800 | h | 10.6 | Partially |
| Example 1 | | | | | adhesive |
| Comparative | 15.7 | <800 | h | 10.5 | Partially |
| Example 2 | | | | | adhesive |
| Comparative | 18.9 | <800 | h | 11.2 | Partially |
| Example 3 | | | | | adhesive |

It can be seen from the above table that in Comparative Examples 1 and 3, when the urea-based monomer is not added to the water-based polymeric pressure-sensitive adhesive or replaced by different types of urea-based monomers, the water-based polymeric pressure-sensitive adhesive has low cross-linking strength and cohesion, resulting in high initial adhesion, low static shear adhesion and peeling force of the label, and adhesion of the surface material with the substrate during the label removing process of the label. In Comparative Example 2, 4-hydroxybutyl acrylate is not added to the water-based polymeric pressure-sensitive adhesive, resulting in poor wettability and low adhesion of the water-based polymeric pressure-sensitive adhesive to the surface material. As a result, the label's static shear adhesion and peeling force are low, and the surface material will adhere to the substrate during the label removing process of the label. For the label materials prepared in Examples 1-4, the water-based polymeric pressure-sensitive adhesive has high compatibility with the surface material, the water-based polymeric pressure-sensitive adhesive has good wettability, adhesion, and bonding property to the surface material, and has high cross-linking strength, and high cohesion. It can provide good initial adhesion, static shear adhesion, and peeling strength to the label, so that the surface material will not adhere to the substrate during the label removing process of the label, and the label removing can be completed quickly. After label removing, there will be no residual adhesive left on the base paper, avoiding affecting the recycling of the base paper. At the same time, by increasing the internal cross-linking strength, the water-based polymeric pressure-sensitive adhesive improves the cohesive strength, thereby improving the hardness of the pressure-sensitive adhesive and reducing its rebound flowability, and there will be no adhesive filament adhesion during the die-cutting process, which avoids rebounding after die-cutting and flowing towards the cut to produce bonding, thus avoiding the situation of two adjacent finished labels adhering to each other after die-cutting. Traditional labels have the problem of adhesion between two adjacent labels after die-cutting, which requires providing a waste discharge zone, resulting in waste of a lot of substrates and adhesive. However, when the water-based polymeric pressure-sensitive adhesive provided by the present disclosure is applied to labels, two adjacent finished labels are less likely to adhere during the die-cutting process, so that no waste discharge zone is provided during the label die-cutting, thereby achieving zero label waste discharge.

Apparently, the above embodiments are only examples for clear explanation and are not intended to limit the implementation. For those having ordinary skills in the art, other different forms of changes or modifications may be made based on the above description. An exhaustive list of all implementations is neither necessary nor possible. The obvious changes or modifications derived therefrom are still within the protection scope of the present disclosure.

What is claimed is:

1. A water-based polymeric pressure-sensitive adhesive, wherein the water-based polymeric pressure-sensitive adhesive is polymerized by the following raw materials in parts by weight: 4-6 parts of water-soluble polyester, 16-18 parts of C₁-C₄ alkyl ester of methacrylic acid, 16-18 parts of C₄-C₈ alkyl ester of acrylic acid, 2-8 parts of ureido methacrylate CHR¹CH—COOR² and 4-5 parts of cycloalkyl ester of methacrylic acid, wherein R¹ is H or methyl, and R² is a linear or cyclic ureido group containing 3-5 carbon atoms, and the cycloalkyl ester of methacrylic acid is C₅-C₂₀ cycloalkyl ester; and
the water-soluble polyester is polymerized by the following raw materials in parts by weight: 1-5 parts of sulfonate for polyester modification, 10-15 parts of hydroxyalkyl ester CHR³CH—COOR⁴OH of (methyl) acrylic acid, 60-80 parts of terephthalic acid and 20-30 parts of ethylene glycol, wherein R³ is H or methyl, and R⁴ is a linear or branched alkylene group containing 2-5 carbon atoms.

2. The water-based polymeric pressure-sensitive adhesive of claim 1, wherein
the ureido methacrylate CHR¹CH—COOR² is ethylene ureaethyl methacrylate.

3. The water-based polymeric pressure-sensitive adhesive of claim 1, wherein
the hydroxyalkyl ester CHR³CH—COOR⁴OH of (methyl) acrylic acid is 2-hydroxyethyl acrylate, 3-hydroxypropyl methacrylate, 2-hydroxypropyl acrylate or 4-hydroxybutyl acrylate.

4. The water-based polymeric pressure-sensitive adhesive of claim 1, wherein
the hydroxyalkyl ester CHR³CH—COOR⁴OH of (methyl) acrylic acid is 4-hydroxybutyl acrylate.

5. The water-based polymeric pressure-sensitive adhesive of claim 1, wherein
the sulfonate for polyester modification is 5-sodium sulfo bis-(hydroxyethyl) isophthalate.

6. The water-based polymeric pressure-sensitive adhesive of claim 1, wherein
the cycloalkyl ester of methacrylic acid is C₅-C₁₀ cycloalkyl ester of methacrylic acid.

7. The water-based polymeric pressure-sensitive adhesive of claim 1, wherein
the viscosity of the water-soluble polyester is 5000 mPas-10000 mPa·s.

8. The water-based polymeric pressure-sensitive adhesive of claim 1, wherein
the preparation method of the water-based polymeric pressure-sensitive adhesive includes:
(1) mixing the water-soluble polyester with C₁-C₄ alkyl ester of methacrylic acid, C₄-C₈ alkyl ester of acrylic acid, ureido methacrylate, cycloalkyl ester of methacrylic acid, and the first part of deionized water, stirring and emulsifying to obtain a monomer pre-emulsion with a solid content of 30%-50%; and
(2) heating 50-100 parts by weight of the second part of deionized water and adding 10%-20% of the monomer pre-emulsion obtained in step (1) for free radical polymerization reaction, and then adding the remaining pre-emulsion dropwise for free radical polymerization reaction, resulting in a product viscosity of 100 mPa·s-500 mPa·s.

9. The water-based polymeric pressure-sensitive adhesive of claim 1, wherein
the preparation method of the water-based polymeric pressure-sensitive adhesive includes:
(1) mixing the water-soluble polyester with C₁-C₄ alkyl ester of methacrylic acid, C₄-C₈ alkyl ester of acrylic acid, ureido methacrylate, cycloalkyl ester of methacrylic acid, and the first part of deionized water, free radical initiator, stirring and emulsifying to obtain a monomer pre-emulsion, wherein the weight of the initiator is 0.3%-0.8% of the total weight of water-soluble polyester, C₁-C₄ alkyl ester of methacrylic acid, C₄-C₈ alkyl ester of acrylic acid, ureido methacrylate and cycloalkyl ester of methacrylic acid; and
(2) heating the second part of deionized water to 78° C.-82° C., adding 10%-20% of the monomer pre-emulsion obtained in step (1), reacting for 15-25 minutes, adding the remaining monomer pre-emulsion dropwise within 2-5 hours, and keeping it at 80° C.-85° C. for 1-2 hours after the adding is completed; cooling down to below 45° C., adjusting the pH value to 7-8, finally adding a wetting agent and a defoaming agent, stirring evenly, and filtering to obtain a water-based polymeric pressure-sensitive adhesive.

10. A label material comprising the water-based polymeric pressure-sensitive adhesive of claim 1, wherein the label material comprises a polyester-based surface material and the water-based polymeric pressure-sensitive adhesive that are bonded to each other.
